(19) United States
(12) Patent Application Publication
(10) Pub. No.: US 2013/0328361 A1
(43) Pub. Date: Dec. 12, 2013

(54) Modular Aircraft Emergency Bed System

(71) Applicant: Paul Michael Egan, West Bend, WI (US)

(72) Inventor: Paul Michael Egan, West Bend, WI (US)

(21) Appl. No.: 13/915,141

(22) Filed: Jun. 11, 2013

Related U.S. Application Data
(60) Provisional application No. 61/658,155, filed on Jun. 11, 2012.

(51) Int. Cl. B64D 11/06

(52) U.S. Cl. CPC B64D 11/06
USPC 297/188.01

(57) ABSTRACT

An aircraft medical emergency treatment system includes an elongate frame that defines a seating arrangement having a seating area shaped to support multiple seated users or a prone user. The seating arrangement includes one or more drawers that movably cooperate with the frame to expose medical accessories such as one or more medical gas cylinders, a gas pump, a power source, a heater, etc. The system includes a container and a stretcher that each removably cooperates with the frame and is stowable in other areas of an aircraft remote from the seating arrangement. The container and stretcher may be shaped to be received between a pair of arms disposed at opposite ends of the seating arrangement and constructed such that the stretcher can be supported by the container when the container is supported by the seating area of the seating arrangement.

### CROSS-REFERENCE TO RELATED APPLICATIONS

This application claims priority to U.S. Provisional Patent Application Ser. No. 61/658,155 filed on Jun. 11, 2012 titled “Modular Aircraft Emergency Bed System” and the entire disclosure of which is incorporated herein.

### BACKGROUND OF THE INVENTION

This invention relates to an emergency patient treatment system and, more particularly, to a convertible aircraft furniture system that provides a seating system that can be converted to provide patient treatment when such a need arises.

The seating arrangement of most commercial aircraft is commonly configured to accommodate a maximum number of passengers and to meet seat assembly weight constraints to meet a tolerable passenger space demand and maximize the financial efficiency associated with operation of such aircraft. The maximum space associated with any given passenger is commonly relegated to the seating layout of the respective aircraft. Although most aircraft include seating that is slightly adjustable to provide upright and at least partly reclined seating orientations, most aircraft seating only tolerates seated passenger orientations. Although such seating systems provide limited passenger comfort, circumstances can arise when it would be desirable or even necessary to accommodate generally prone positioning of a passenger. Medical emergencies are one such instance wherein a more prone passenger orientation is desired or necessary to effectuate a desired treatment or attention to the pertinent in-flight health emergency.

Respiratory distress is one such event wherein prone positioning of a patient can beneficially mitigate patient distress. Prone positioning of a patient, commonly understood as raising the legs and declining the torso relative to a vertical orientation and to be more generally aligned with the hips even though not in a gravitationally horizontal position, is commonly understood, for example, to improve patient oxygenation, improve respiratory mechanics, homogenize pleural pressure gradients, improve alveolar inflation and ventilation distribution, increase lung volume and reduce atelectatic regions, facilitate drainage of secretions, and to reduce ventilator-associated lung injury.

Achieving a generally prone patient orientation in an in-flight aircraft environment presents problems unique to the environment. For instance, prone positioning of a passenger can be achieved by placement of the patient in an aisle. Unfortunately, laying a distressed passenger in an aisle has several inherent drawbacks. For instance, witnessing such an event may cause anguish to other passengers, leaves the distressed passenger generally unsecured to the underlying aircraft, obstructs egress passageways, and provides only very limited access to the distressed passenger by those capable of diagnosing and rendering treatment to the distressed passenger.

Positioning a distressed passenger in an aisle may also substantially limit access of the care provider to any medical accessories associated with a desired treatment of the distressed passenger. That is, medical treatment systems and/or accessories, and/or access thereto, are commonly only located at fore and aft available spaces of the aircraft. Commonly, a patient located in an aisle is impassable such that treatment personnel must be assisted by others who can travel to the fore and aft stowage locations to retrieve requested treatment accessories. Each of the considerations above detracts from expeditious and efficient treatment of a distressed passenger and can disrupt the in-flight experience of non-afflicted passengers. Providing more robust patient systems, such as gurneys or the like, that can be stored or stowed in non-use locations tends to detract from efficient space utilization of the underlying aircraft. That is, such a system detracts from the underlying objective of transporting a maximum number of non-distressed passengers with each use of the underlying aircraft due to the omission of usually multiple seats from the aircraft seating layout to accommodate the possible but still infrequent use of the gurney.

Accordingly, there is a need for an aircraft seating system that is lightweight and usable as seated passenger seating during non-emergency situations and which accommodates prone positioning of a distressed passenger during in-flight health emergency situations. Preferably, the seating system is constructed to accommodate storage of one or more medical accessories associated with treatment of a distressed passenger and to cooperate with other movable medical accessories, such as supplemental medical accessory containers or the like and/or a stretcher associated with supporting and/or transporting a patient in a generally prone as compared to a more seated orientation.

### SUMMARY OF THE INVENTION

The present invention provides an aircraft furniture system that includes a couch or the like having one or more cushions that extend along a seat thereof. The cushions can be secured to the couch or removable therefrom. The system includes a stowable medical consumable accessory container that removably cooperates with the frame defined by the couch. A stowable stretcher can removably cooperate with the frame or an upper surface of the stowable medical consumable accessory container so as to support a person in need of medical attention in a generally prone position. One or more slidable drawers are supported by the frame generally beneath the seating area or the cushions associated therewith. The one or more drawers are configured to contain medical accessories such as gas tanks, heat and/or power sources, air, gas, and/or vacuum pumps, etc. Such a furniture assembly provides for a limited size and mass associated with systems that must be retrieved from stored or stowage locations during medical emergencies that may occur during operation of an aircraft and presents a furniture configuration that can be used for passenger seating during non-emergency aircraft use.

One aspect of the invention contemplates an aircraft seating system that includes a frame that has a length that is sufficient to support a prone use. The system includes at least one cushion that cooperates with the frame to accommodate use of the couch by users in a passenger cabin of an aircraft. A first drawer and a second drawer slidably cooperate with the frame and are movable between open and closed positions to expose the contents of the respective drawer. The first drawer is configured to receive a first medical accessory and the second drawer is configured to support a second medical accessory for use during an in-flight medical emergency. Such a system allows treatment of a passenger experiencing an in-flight medical emergency with the treated passenger in a generally prone position.

Another aspect of the invention that is usable with one or more of the features of the present invention contemplates an aircraft furniture system that includes a couch having a frame that defines a longitudinal length with arm sections at opposite ends thereof. At least one drawer slidably cooperates with the frame beneath a seat thereof. The drawer defines a medical accessory storage compartment configured to receive at least one medical gas cylinder. The system includes a stowable stretcher that removably cooperates with the couch to support a patient in a prone and secured orientation within the aircraft cabin.

A further aspect of the invention contemplates a method of providing an aircraft medical treatment system. The method includes providing a frame having a seating section that has a longitudinal length and a lateral depth that are sufficient to accommodate more than one person in seated orientations and a single person in a prone orientation. At least one drawer is attached to the frame so that the drawer is disposed below the seating section when the drawer is closed. An interior surface of the drawer is shaped to removably secure at least one medical gas cylinder to the drawer in a generally horizontal orientation. Such a system provides an aircraft medical treatment system that can be utilized for seating when no emergency health conditions exist and provides expedient access to devices and systems associated with treatment of emergency medical conditions.

These and various other features, aspects and advantages of the present invention will be made apparent from the following detailed description taken together with the drawings, which together disclose the best mode presently contemplated of carrying out the invention.

### BRIEF DESCRIPTION OF THE DRAWINGS

The drawings illustrate the best mode presently contemplated of carrying out the invention.

In the drawings:

FIG. 1 is a perspective view of a representative embodiment of an aircraft furniture system according to the present invention;

FIG. 2 is a view similar to FIG. 1 and shows a pair of drawers of the furniture system in an open position and a stowable medical accessory container and a stowable stretcher engaged with the aircraft furniture system;

FIG. 3 is a front elevation view of the aircraft furniture system shown in FIG. 2;

FIG. 4 is an exploded perspective view of the aircraft furniture and medical accessory system shown in FIG. 2; and

FIG. 5 is view similar to FIG. 2 and shows the drawers and surface covering removed from the aircraft furniture system exposing a space frame thereof.

### DETAILED DESCRIPTION OF THE INVENTION

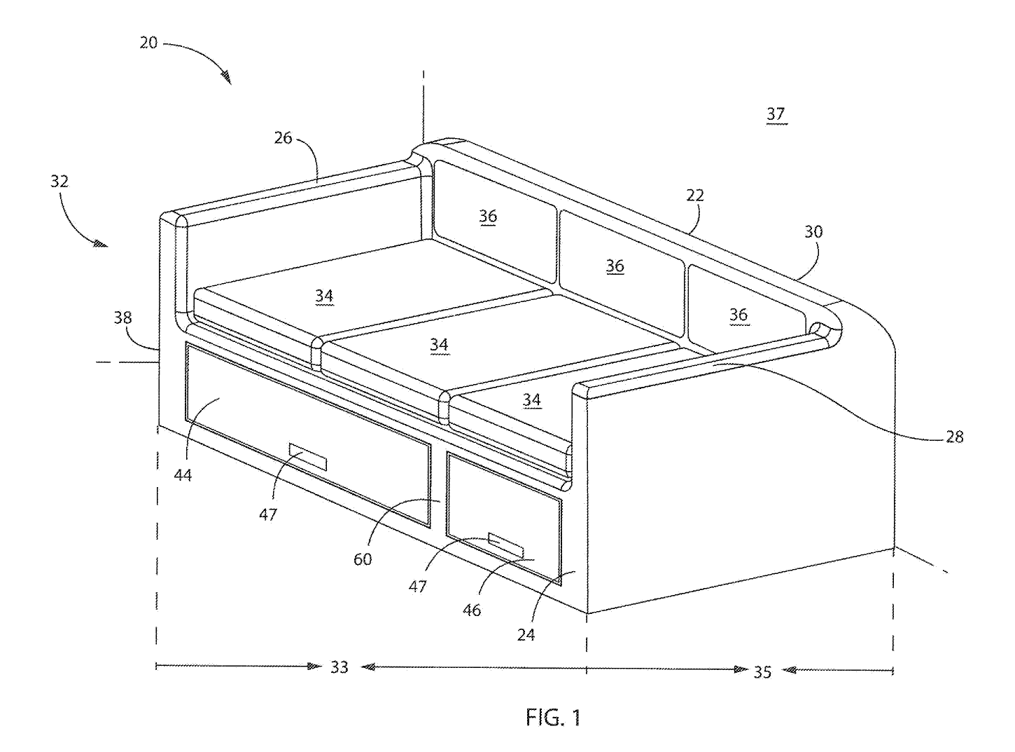

A specific embodiment of the present invention will now be further described by the following, non-limiting example which will serve to illustrate various features of the invention. With reference to the drawing figures, in which like reference numerals designate like parts throughout the disclosure, a representative embodiment of a seating arrangement in the form of a couch 22 of a medical emergency aircraft furniture system or an aircraft furniture system 20 in accordance with the present invention is shown in FIG. 1. Couch 22 has a shape that is defined by a frame 24 having a first arm 26, the second arm 28, a back 30, and a seating area 32. Seating area 32 representatively includes one or more seat cushions 34 and back cushions 36 that can be secured to or removable from frame 24. Seating area 32 has a longitudinal length, indicated by arrow 33, and a depth, indicated by arrow 35, such that seating area 32 is preferably shaped to support one or more seated users or a prone user between arms 26, 28. Couch 22 is constructed to be disposed in the passenger cabin of an aircraft 37 such that aircraft passengers or non-pilot personnel can utilize the couch 22 during operation of aircraft 37.

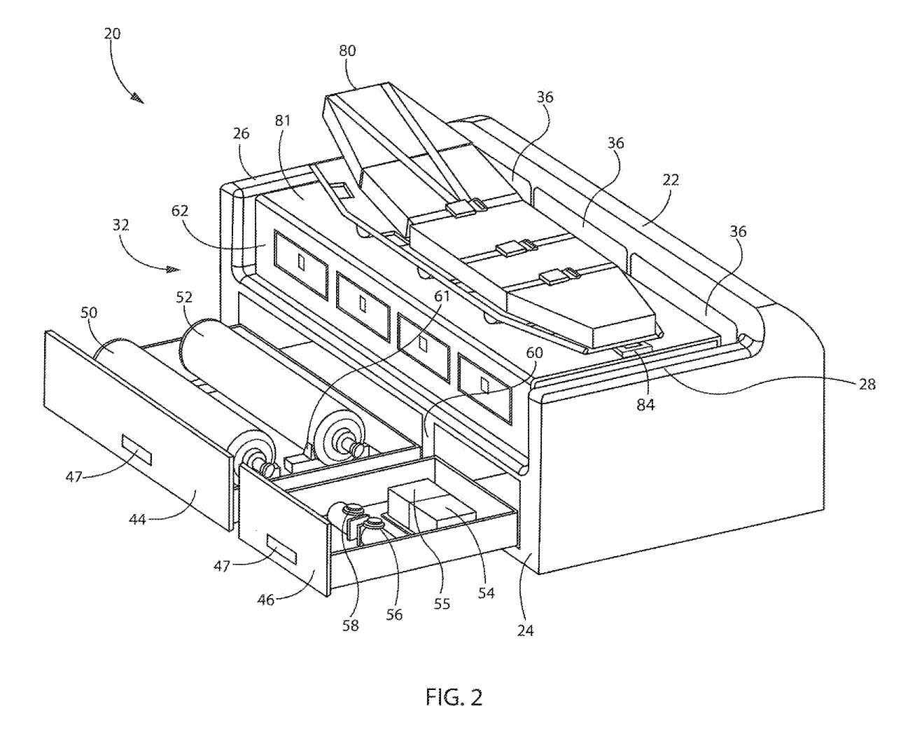

Referring to FIGS. 1 and 2, frame 24 includes a first cavity 38 and a second cavity 40 that are generally disposed beneath seating area 32. A first drawer 44 slidably cooperates with first cavity 38 and a second drawer 46 slidably cooperates with second cavity 40 of frame 24. Drawers 44, 46 movably cooperate with frame 24 so as to be movable to a closed, stowed, or stored position (as shown in FIG. 1) wherein the volume associated with drawers 44, 46 is disposed in cavities 38, 40 (FIG. 2), respectively, and generally enclosed by frame 24. As shown in FIG. 2, when one or more of drawers 44, 46 is in an access or open position, the contents of the respective drawers 44, 46 can be accessed by personnel within aircraft 37 and proximate couch 22 for treatment of a distressed passenger. Drawers 44, 46 may include an optional handle or finger pull, and/or a lock or catch 47 so as to be securable relative to frame 24 when positioned in either of the open or closed positions. Representatively, drawers 44, 46 are constructed to cooperate with frame 24 in a manner that requires user interaction with the drawer to effectuate operation of the same and similarly to prevent unintended translation of drawers 44, 46 caused by movement of the underlying aircraft 37. When oriented in the closed position, drawers 44, 46 do not interfere with user's normal seated or laying/prone interaction with seating area 32 of couch 22. Seating area 32 of frame 24 of couch 22 extends along longitudinal length 33 between arms 26, 28 to accommodate multiple seated users or a single prone user between arms 26, 28.

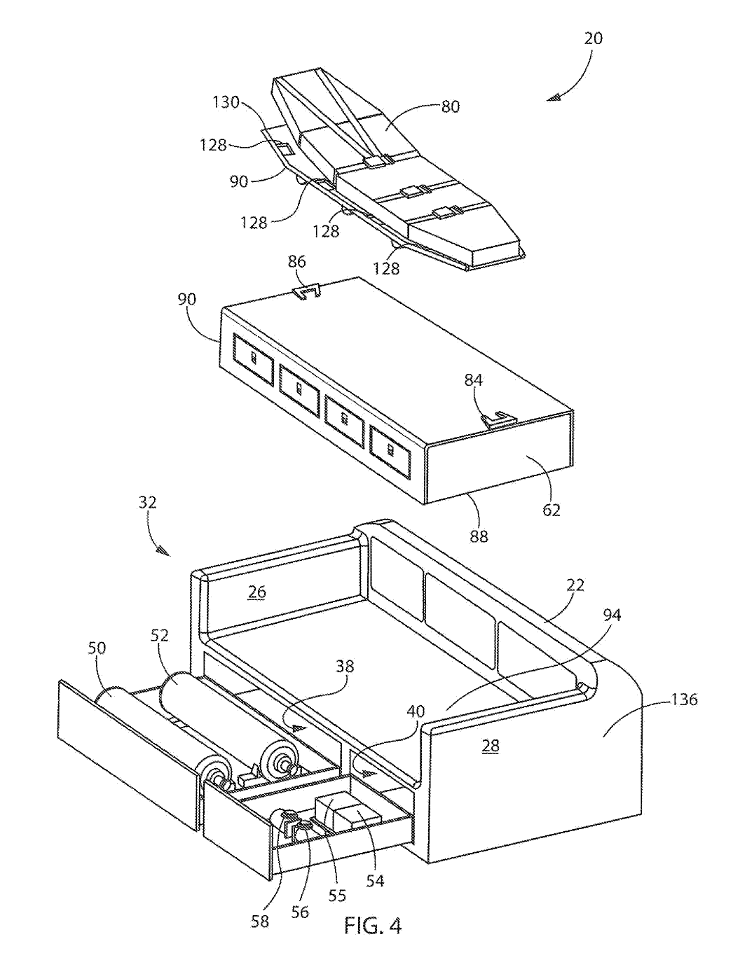

As shown in FIGS. 2 and 4, one or more medical accessories, such as a first gas cylinder 50, a second gas cylinder 52, a heat source 54 and/or a power source 55, and one or more air or gas pressure or vacuum pumps 56, 58 are collectively disposed in drawers 44, 46. Although not shown, it is appreciated that drawers 44, 46 may also include the tubing and mask associated with communicating the contents of one or more of cylinders 50, 52 to passengers supported by couch 22. Gas cylinders 50, 52 can be configured to contain and deliver any of a number of gases consumed or otherwise delivered to a distressed passenger or patient during periods of physical or medical treatment, such as oxygen for example. In a representative embodiment, frame 24 includes a partition 60 that isolates first cavity 38 from second cavity 40 such that the contents of respective drawers 44, 46 can be isolated from one another. One or more of drawers 44, 46 associated with cylinders 50, 52 may include one or more cradles 61 (FIG. 2) for maintaining a desired orientation of cylinders 50, 52 relative thereto. Cradles 61 may be constructed to cooperate with a curvilinear side of cylinders 50, 52 such that cylinders 50, 52 can be maintained in a generally horizontal orientation such that the longitudinal axes of the respective cylinders are aligned with one another. Additionally, selective operation of drawers 44, 46 allows treating personnel close spatial positioning along the longitudinal length of a distressed passenger or patient should such access be required for effective treatment of any given aircraft passenger emergency situation.

Referring to FIGS. 2-5, seat cushions 34 associated with seating area 32 of couch 22 may removably cooperate with frame 24 to accommodate cooperation of a stowable or supplemental consumable medical accessory container 62 with frame 24. Alternatively, it is appreciated that container 62 may be disposed generally atop cushions 34. Container 62 may be movable such that it that can be retrieved from a stowed position or location of aircraft 37 for selective cooperation with couch 22 when treatment of a passenger is necessary. As used herein, those portions of system 20 that are stowable remote from couch 22 are merely intended or envisioned as being contained, stowed, or stored in aircraft 37 remote from couch 22. In most aircraft configurations, stowage can be interpreted as cargo areas as well as aircraft personnel areas which are also commonly isolated from non-staff passengers.

Representatively, container 62 is configured to fit slidably between arms 26, 28 of frame 24 of couch 22. Although seat cushions 34 are shown removed from frame 24, it is envisioned that couch 22 and container 62 could be configured to cooperate with one another with or without the removal of seat or back cushions 34, 36. It is appreciated that some patient treatment processes and/or cushion and frame constructions may lend themselves more to one of removal of cushions 34, 36 or leaving cushions 34, 36 in place.

A suitable latch or retention mechanism may be interposed between container 62 and seating area 32, which enables container 62 to maintain a fixed position relative to couch 22 when in use. It is envisioned that such a retention mechanism can be provided as one or more removable and/or securable straps, a more rigid latching mechanism, interfering or overlapping geometric interfaces, and/or combinations thereof. Container 62 may include one or more drawers or compartments 64, 66, 68, 70 that are each shaped to accommodate storage of consumable medical products, such as gauze, tapes, ointments or topical treatments, pills and/or other intravenous medications and materials associated with application of the same, a defibrillator, etc., and/or other desired accessories as may be necessary during treatment of a distressed passenger or patient. Each compartment 64, 66, 68, 70 may include an operable latch, catch or lock 72, 74, 76, 78 associated with securing the respective drawer or door associated with compartments 64, 66, 68, 70 relative to the body of container 62. The one or more catches or locks 72, 74, 76, 78 may be constructed to be securable so as to limit access to the contents of container 62 to a restricted user or group of users. For instance, the one or more catches or locks 72, 74, 76, 78, and/or drawers when compartments 64, 66, 68, 70 are provided in such a configuration, are constructed to cooperate with container 62 in a manner wherein the respective door or drawer maintains a relative position even during aircraft operation.

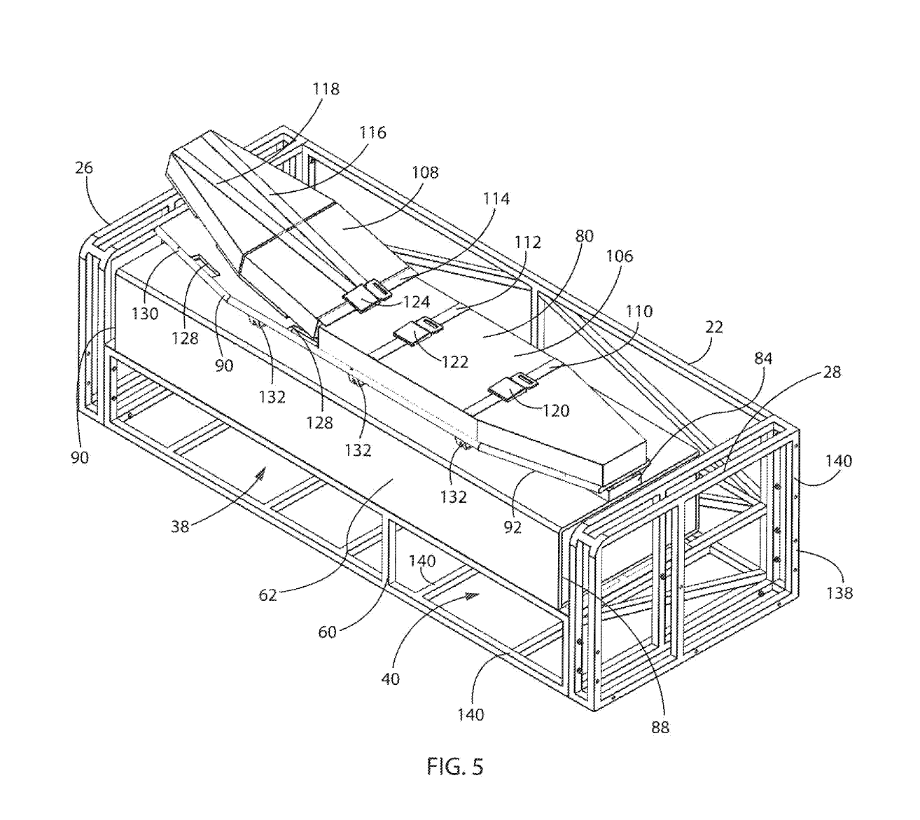

Still referring to FIGS. 2-5, aircraft furniture system 20 may include a stretcher 80 that removably cooperates with an upper surface 82 of container 62. As shown in FIGS. 4 and 5, in a representative embodiment, container 62 includes a pair of handles 84, 86 that are disposed at generally opposite longitudinal ends 88, 90 of container 62. Handles 84, 86 are shaped to allow expedient transport of container 62 between couch 22 and a stowed location. As shown in FIG. 5, handles 84, 86 are shaped to cooperate with an underside 92 of stretcher 80 to index the position of stretcher 80 relative thereto. It is appreciated that one or more of handles 84, 86 and stretcher 80 can include a selectively operable catch or latch associated with the overlapping interface between handles 84, 86 and underside 92 of stretcher 80 to provide a selectively securable and indexed orientation between container 62 and stretcher 80. It is further appreciated that an upward facing surface 94 (FIG. 4) of couch 22 could include receiving structures having a shape and orientation similar to handles 84, 86 to allow a similar interaction between stretcher 80 and surface 94 of couch 22 when the contents of container 62 are unnecessary for the desired treatment associated with a distressed passenger.

Referring to FIGS. 4 and 5, stretcher 80 is shaped to accommodate a non-seated or generally prone user whose treatment may or may not require application, use, or consumption of the contents associated with container 62, use of one or more of gas cylinders 50, 52, use of heater 54 and/or power source 55, and/or the operation of one or more of pumps 56, 58. As used herein, a prone position is intended to encompass any desired passenger position wherein the passenger can attain a more horizontal position than a seated or reclined but still generally seated orientation. As disclosed above, a suitable latch, retention mechanism, or overlapping geometric interface is interposed between stretcher 80 and upper surface 81 of container 62 and/or upper surface 94 of the seating area of couch 22 which enables stretcher 80 to be secured in position relative to couch 22 and/or container 62. As disclosed above, stretcher 80 is constructed to securely cooperate with couch 22 for those medical emergency situations wherein the contents of one of more of drawers 44, 46 are sufficient for a desired treatment of the passenger distress. Stretcher 80 may removably cooperate with container 62 and/or couch 22 to allow expedient removal of stretcher 80 from aircraft 37 for those situations when the distressed passenger is unable to disembark under his or her own power and/or it is desired to maintain a prone positioning of the distressed passenger for continued or further treatment by ground medical treatment services.

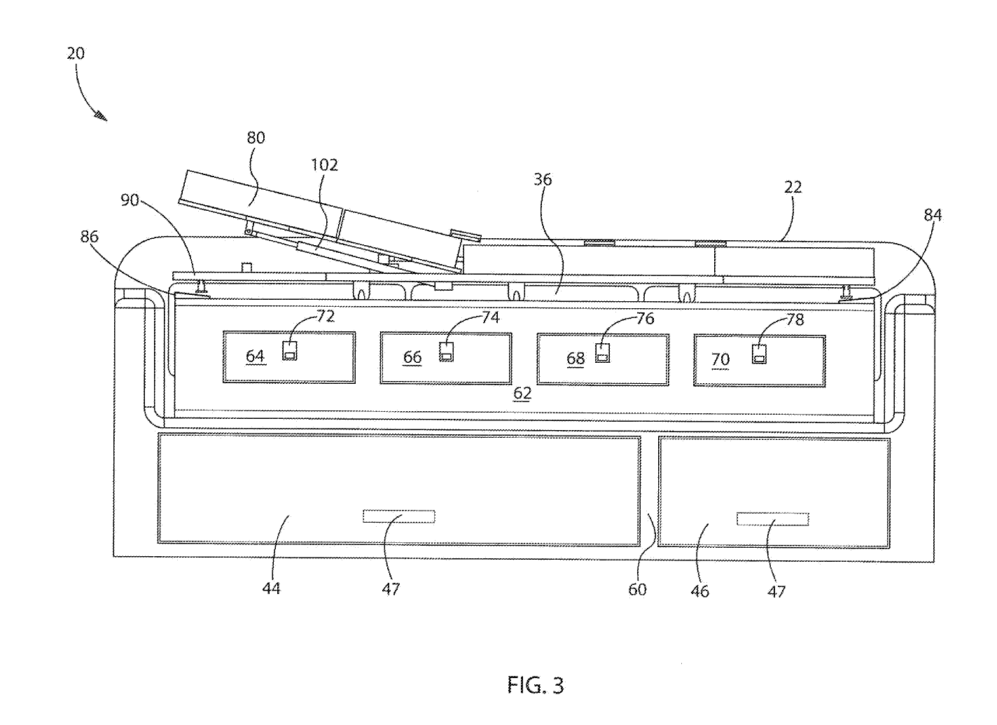

Referring to FIGS. 3-5, stretcher 80 includes a frame 96, an upper abdomen and torso or upper support portion 98, and a lower abdomen and extremity or lower support portion 100. The upper and lower support portions 98, 100 are pivotably connected to one another and/or to frame 90 to allow upper support portion 98 to be inclined relative to lower support portion 100 when lower support portion 100 is oriented horizontally. A variable length actuator 102 is connected between frame 96 and upper support portion 98 such that upper support portion 98 can achieve and maintain various desired positions between being generally aligned with a longitudinal axis of lower support portion 100 and oriented at an approximately right angle relative thereto. Such a construction allows stretcher 80 to support a distressed passenger in a generally fully horizontal position and/or positions wherein the torso of a distressed passenger is inclined or elevated relative to his or her legs as may be desired for an intended treatment protocol or to accommodate comfort of the patient or distressed passenger. It is appreciated that other structures, such an adjustable strut and/or linkages that extend between upper support portion 98 and frame 90 of stretcher 90 may be provided to facilitate similar adjustability.

Each of upper support 98 and lower support 100 includes a pad or cushion 106, 108 associated with supporting a distressed passenger. One or more straps 110, 112, 114, 116, 118 are secured to stretcher 80. One or more of straps 110, 112, 114, 116, 118 include a securing mechanism such as a buckle 120, 122, 124 associated with providing an adjustable and selectively securable connection of the respective straps 110, 112, 114, 116, 118 to respective portions thereof as well as the underlying generally rigid structures of stretcher 80. Such a construction allows stretcher 80 to be configured to secure distressed passengers of various sizes relative thereto.

Still referring to FIGS. 4 and 5, frame 90 of stretcher 80 may include a series of grip sites or grab holds 128 that are generally disposed about a perimeter 130 thereof. Grab holds 128 allow various personnel associated with assisting a distressed passenger to transport the distressed passenger supported by stretcher 80 without the assistance of the distressed passenger. Grab holds 128 provide a robust and ergonomic interaction for the assisting personnel to interact with stretcher 80. As shown in FIG. 5, stretcher 80 includes a number of supports 132 that extend from the underside 92 of stretcher 80. Supports 132 provide a gap 134 between underside 92 of stretcher 80 and surface 81 of container 60 and/or surface 94 of couch 22 to facilitate convenient interaction with the assisting personnel with grab holds 128. That is, gap 134 allows the assisting personnel to slide a portion of their hand between frame 90 of stretcher 80 and the underlying supporting surface without first elevating frame 90, and the passenger associated with stretcher 80, to effectuate the desired gripped interaction with a respective grab hold 128.

Referring to FIGS. 4 and 5, couch 22 includes a covering material 136 (FIG. 4) that is stretched over frame 24, which is further defined as a space frame 138 (FIG. 5) that defines the general shape of couch 22. It is appreciated that material 136 can be any number of materials and can be provided with padding disposed between the exposed areas of covering material 136 and space frame 138. It is appreciated that the covering and associated padding can be provided in a number of manners including as a single layer and/or multiple layers wherein the padding material is disposed between the finish covering material and space frame 38.

Referring to FIG. 5, space frame 138 includes a number of interconnected elongate members 140 that define the general finished shape of couch 22. It is appreciated that space frame 138 can be formed in a number of ways, can be formed from a number of materials, and can be formed from various numbers of connected discrete members. Representatively, space frame 138 is constructed of a number of hollow tube sections that define the shape of couch 22. It is further appreciated that space frame 138 may be constructed of lightweight materials such as fiber reinforced materials and/or aircraft aluminum to limit the weight associated with couch 22 so as to maintain or improve the efficiency associated with operation of the underlying aircraft 37. The space frame 138 may be constructed to provide a rigid seating configuration that can support multiple passengers in seated orientations and a single passenger or distressed passenger in a prone orientation. Space frame 138 is also shaped to define the first and second cavities 38, 40 associated with supporting the slidable interaction of drawers 44, 46 therewith. It is further appreciated that space frame 138 may be constructed to support or receive one or more optional variable length slides associated with improving the slidable interaction of drawers 44, 46 (FIG. 3) therewith. It is appreciated that such optional slides can be positioned either beneath or at the opposite lateral ends of the respective drawer 44, 46 to improve the desired slidable operability of drawers 44, 46 relative to space frame 138.

The variable and generally prone orientation of the patient as well as the immediate passenger cabin access to those accessories associated with drawers 44, 46 improves the response time associated with initial patient assessment and treatment. Although couch 22 is positioned in the passenger cabin of an aircraft and useable by passengers as a couch during non-emergency situations, aircraft emergency medical response times can be improved as a large portion of the medical response equipment is already positioned in the aircraft passenger cabin and is in the vicinity of a desired treatment area whereas bulky, awkward, and/or heavy response gurneys and/or containers need not be retrieved from one or more stowed locations about the aircraft prior to the initiation of a desired emergency medical response. It is envisioned that even the stowable structure of system 20, such as container 62 and stretcher 80, can be stowed at aircraft locations proximate couch 22 but even if not, are compact and lightweight enough for a single even moderately fit person to retrieve and associate container 62 and/or stretcher 80 with couch 22 during emergency events requiring a medical response. Aircraft furniture system 20 provides a seating system that is usable by more than one passenger during non-emergency use of aircraft 37 and which can be quickly configured to accommodate a prone user or distressed passenger at locations that do not otherwise obstruct passenger movement paths, allows isolation of the distressed passenger treatment from remaining passengers, and allows expedient access to the medical treatment systems and accessories for treatment of distressed passengers.

Various alternatives and embodiments are contemplated as being within the scope of the following claims particularly pointing out and distinctly claiming the subject matter regarded as the invention.

I claim:

1. An aircraft seating system comprising:
a frame having a length sufficient to support a prone use;
at least one cushion that cooperates with the frame to accommodate use of the seating by users in a passenger cabin of an aircraft; and
a first drawer and a second drawer that slidably cooperate with the frame, the first drawer configured to receive a first medical accessory and the second drawer configured to support a second medical accessory for use during an in-flight medical emergency.

2. The aircraft seating system of claim 1 further comprising a container that removably cooperates with the frame and is configured to be stored in the aircraft at a position remote from the frame of the aircraft seating during health care non-emergency use of the aircraft.

3. The aircraft seating system of claim 1 wherein the first medical accessory is further defined as at least one medical gas tank and the second medical accessory is further defined as at least one of a power source and a heater.

4. The aircraft seating system of claim 1 further comprising a stretcher that removably cooperates with the frame and supports a user in need of medical attention.

5. The aircraft seating system of claim 4 further comprising a medical supply container that removably cooperates with the frame and is configured to be stored in the aircraft at a position remote from the aircraft seating, wherein the medical supply container is constructed to support a prone user supported by the stretcher.

6. The aircraft seating system of claim 5 wherein the medical supply container is shaped to fit between a pair of arm portions that are defined by the frame and are disposed at generally opposite longitudinal ends of frame.

7. The aircraft seating system of claim 6 wherein the medical supply container includes at least one drawer or a door that allows selective access to a cavity of the medical supply container.

8. An aircraft furniture system comprising:
a seating arrangement having a frame that defines a longitudinal length with arm sections at opposite ends thereof;
at least one drawer that slidably cooperates with the frame beneath a seat thereof, the at least one drawer defining a medical accessory storage compartment configured to receive at least one medical gas cylinder; and
a stowable stretcher that removably cooperates with the seating arrangement to support a prone patient.

9. The aircraft furniture system of claim 8 further comprising a stowable medical accessory container that is shaped to removably cooperate with the frame of the seating arrangement to be disposed between the arm sections and beneath the stowable stretcher.

10. The aircraft furniture system of claim 9 further comprising another drawer that slidably cooperates with the frame next to the at least one drawer and is configured to contain at least one of a power source, a gas pump, and a heat source.

11. The aircraft furniture system of claim 9 wherein the stowable medical accessory container includes multiple compartments and each compartment of the stowable medical accessory and each drawer of the frame are at least one of securable or lockable.

12. The aircraft furniture system of claim 8 further comprising a first cradle formed in the at least one drawer and shaped to cooperate with a curvilinear side of the at least one medical gas cylinder to define a position of the at least one gas cylinder relative to a cavity defined by the at least one drawer.

13. The aircraft furniture system of claim 12 further comprising a second cradle formed in the at least one drawer and shaped to cooperate with a curvilinear side of another medical gas cylinder so that a longitudinal axis of the at least one medical gas cylinder and a longitudinal axis of the another medical gas cylinder are parallel to one another.

14. The aircraft furniture system of claim 13 wherein the longitudinal axis of the at least one medical gas cylinder and a longitudinal axis of the another medical gas cylinder are oriented in a crossing direction relative to a direction of movement of the at least one drawer.

15. A method of providing an aircraft medical treatment system, the method comprising:
providing a frame having a seating section that has a longitudinal length and a lateral depth that are sufficient to accommodate more than one person in seated orientations and a single person in a prone orientation;
attaching at least one drawer to the frame so that the drawer is disposed below the seating section when the drawer is closed; and
shaping an interior surface of the drawer to removably secure at least one medical gas cylinder to the drawer in a generally horizontal orientation.

16. The method of claim 15 further comprising flanking the seating section with a pair of arm sections.

17. The method of claim 16 further comprising providing a stretcher that removably cooperates with the seating section and is stowable at a location within an aircraft that is remote from the frame.

18. The method of claim 17 further comprising providing a container that removably cooperates with the seating section and is shaped to fit between the stretcher and the seating section and the pair of arm sections and further comprising forming the container to define a plurality of cavities that are individually accessible and shaped to securely accommodate medical accessories so as to prevent translation of the medical accessories during transport of the container within a respective aircraft.

19. The method of claim 18 further attaching another drawer to the frame proximate the at least one drawer and below the seating section.

20. The method of claim 19 further comprising attaching the at least one drawer and the another drawer to the frame so that both the at least one and another drawers are movable in a direction perpendicular to a front rail of the frame.
